(19) United States
(12) Patent Application Publication
(10) Pub. No.: US 2004/0186787 A1
(43) Pub. Date: Sep. 23, 2004

(54) Method and apparatus for managing storage unit rental information

(76) Inventors: Buck Brown, Collierville, TN (US); Kenney Mike, Gilbert, AZ (US); Keaton Joel, Linwood, PA (US); Haugh Michael, Memphis, TN (US); Rogers Phil, Collierville, TN (US); Schrimsher Dave, Frederick, MD (US); Wilson Don, Paris (FR)

Correspondence Address: Buckley, Maschoff, Talwalkar & Allison LLC, Five Elm Street, New Canaan, CT, 06840, US

(21) Appl. No.: 10/393,778

(22) Filed: Mar. 21, 2003

(51) Int. Cl. G06F 17/60

(52) U.S. Cl. 705/26; 705/30

(57) ABSTRACT

Methods and apparatus are provided for managing information relating to rental of storage units. A central data processing system maintains a database. A respective facility computer is located at each of a plurality of storage unit rental facilities. The facility computers are configured to engage in data communication with the central data processing system. The rental facilities each include a plurality of storage units. The facility computers upload to the central data processing system rental transaction data related to rentals of the storage units. The rental transaction data is stored in the database.

### FIELD

The present invention relates to systems and methods for managing information concerning rental of storage units.

### BACKGROUND

Many individuals and businesses find it desirable to rent self-storage units to store items that may not be immediately needed and/or to free up space in homes or places of business. Customers for self-storage units have varying needs, and storage units accordingly have varying characteristics. For example, storage units come in various sizes, are climate-controlled to various degrees or not at all, may be located at various locations in a storage unit rental facility and may be accessible in various ways, such as directly from the outside or from inside the rental facility, via stairs, via an elevator, and so forth. These variations and others in unit characteristics, and a corresponding variability in the rental prices charged for storage units in a single rental facility, make for significant complexities in record-keeping.

For operators of chains of storage unit rental facilities, record-keeping challenges are compounded. The assignee hereof, Storage USA, Inc., operates a chain of more than 500 storage unit rental facilities. Particularly for such a large number of properties, previously proposed information management systems have not satisfied all the needs of the organization.

### SUMMARY

To alleviate problems inherent in the prior art, the present invention introduces improved systems and methods for managing information relating to rental of self-storage units (hereinafter referred to as “storage units”)

According to one embodiment, a system includes a central data processing system in which a database is maintained. The system also includes a plurality of facility computers, each of which is located at a respective rental facility. The rental facilities each include a plurality of storage units that are rented or available for rental to customers. The facility computers are configured to engage in data communication with the central data processing system. The facility computers upload rental transaction data to the central data processing system on a daily basis. The rental transaction data is related to rentals of the storage units. The rental transaction data is stored in the database maintained in the central data processing system.

As used herein and in the appended claims, “daily” and “on a daily basis” refer to an activity that is performed five times per week or more on average and may refer to an activity performed more frequently than once a day. In some embodiments, the rental transaction data may be uploaded on a real-time basis, which may also be considered a “daily” basis.

In some embodiments the database may store historical rental transaction data going back one, two or three years or more. In some embodiments the rental transaction data may include demographic information relating to customers and/or customers' specific reasons for renting self-storage units.

According to other embodiments, a method includes collecting rental transaction data at each of a plurality of rental facilities, and uploading the collected rental transaction data to a central data processing system on a daily basis (e.g., on a real-time basis).

With these and other advantages and features of the invention that will become hereinafter apparent, the invention may be more clearly understood by reference to the following detailed description of the invention, the appended claims, and the drawings attached herein.

### BRIEF DESCRIPTION OF THE DRAWINGS

FIG. 1 is a block diagram of a rental information management system according to some embodiments.

FIG. 2 is a block diagram of an alternative rental information management system according to some embodiments.

FIG. 3 is a block diagram that shows some details of a central data processing system that is part of the rental information management system of FIG. 1 or 2.

FIG. 4 is a block diagram that illustrates functional software components of the system of FIGS. 1-3.

FIG. 5 is a schematic illustration of some functional blocks of a property management component of the software illustrated in FIG. 4.

FIG. 6 is a flowchart which illustrates a process performed by the rental information management system of FIG. 1 or 2.

FIG. 7 is a graph that illustrates an opportunity cost function that may be employed by a revenue management software component of the software illustrated in FIG. 4.

FIGS. 8A-8D are tabular representations of relevance matrices that may be stored in the central data processing system of FIG. 3 and employed by the revenue management software component.

### DETAILED DESCRIPTION

System Overview

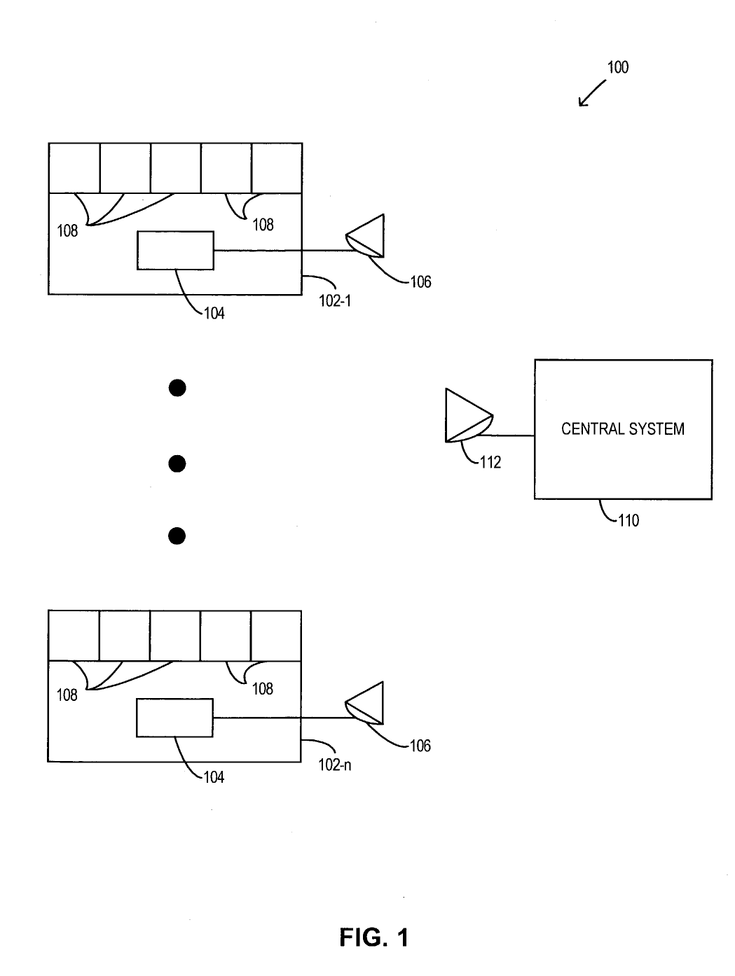

Turning now in detail to the drawings, FIG. 1 is a block diagram of a storage unit information management system provided according to some embodiments of the present invention. In FIG. 1, reference numeral 100 generally indicates the information management system. The information management system 100 may serve a chain of storage unit rental facilities 102, all of which may be located remotely from each other. The number of rental facilities (sometimes referred to as “properties”) may number in the hundreds, or even thousands, although only two rental facilities 102-1 and 102-n are explicitly shown in the drawing.

Located at each of the rental facilities 102 is a respective facility computer 104. The facility computers 104 may, for example, be conventional personal computers that are programmed in accordance with aspects of the invention. The facility computers may be employed to enter, store and manage information relating to rental and other activities at the respective rental facilities. More details of the functions of the facility computers will be provided below.

Each of the facility computers 104 is operatively coupled to a respective satellite earth station 106. The satellite earth stations 106 allow the facility computers 104 to engage in data communication via a communication satellite, which is not shown.

Each of the rental facilities 102 includes a plurality of storage units 108, which are rented by customers or are available for rental by customers. Although only a relatively few storage units 108 are shown with respect to each rental facility 102, in practice each rental facility may include a large number of storage units, e.g. in the hundreds. Also, as will be appreciated from earlier discussion, the storage units may vary in terms of size and other characteristics, both within each rental facility and from rental facility to rental facility, although such differences in storage units are not indicated in the drawing.

The information management system 100 also includes a central data processing system 110, which may, for example, be located remotely from all of the rental facilities 102. The central data processing system 110 may, for example, be constituted by a conventional mainframe computer or another type of computer, programmed in accordance with aspects of the present invention. The central data processing system 110 is operatively coupled to a satellite earth station 112, so that the central data processing system 110 is able to engage in data communication via satellite with the facility computers 104 located at the rental facilities 102. As will be seen, the satellite earth stations 106 at the rental facilities 102 may be employed to transmit to the satellite earth station 112, via a communication satellite, storage unit rental transaction data generated at the facility computers 104. The satellite earth station 112 may receive the rental transaction data, which is stored in the central data processing system 110. Thus rental transaction data may be transmitted from the rental facilities 102 to the central data processing system 110 via satellite uplinks provided through the satellite earth stations 106.

Other features and functions of the central data processing system 110 will be described below.

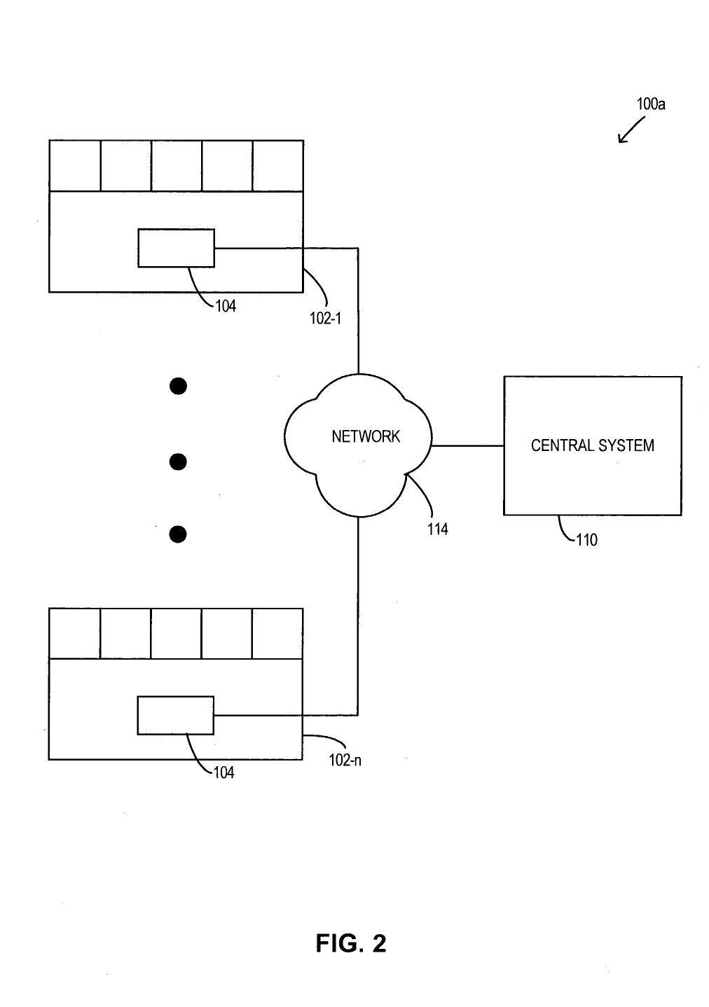

An alternative embodiment of the information management system (generally indicated by reference numeral 100a) is illustrated in block diagram form in FIG. 2. The information management system 100a depicted in FIG. 2 may differ from that of FIG. 1 only in terms of the manner in which data communication links are provided between the central data processing system 110 and the facility computers 104. That is, the satellite earth stations of FIG. 1 may be omitted from the information management system 100a of FIG. 2, and instead the facility computers 104 may be linked to the central data processing system 110 by a data network 114 that does not include direct satellite links. The data network 114 may be, for example, the Internet, a private data network (e.g., a wide area network (WAN)) or a combination of private and public networks. The facility computers 104 and the central data processing system 110 may be connected to the data network 114 by digital subscriber lines (DSL) and/or Frame Relay network connections and/or other fast data channels.

In some embodiments of the information management system, both non-satellite-based and satellite-based data communication may be employed to link the facility computers 104 to the central data processing system 110.

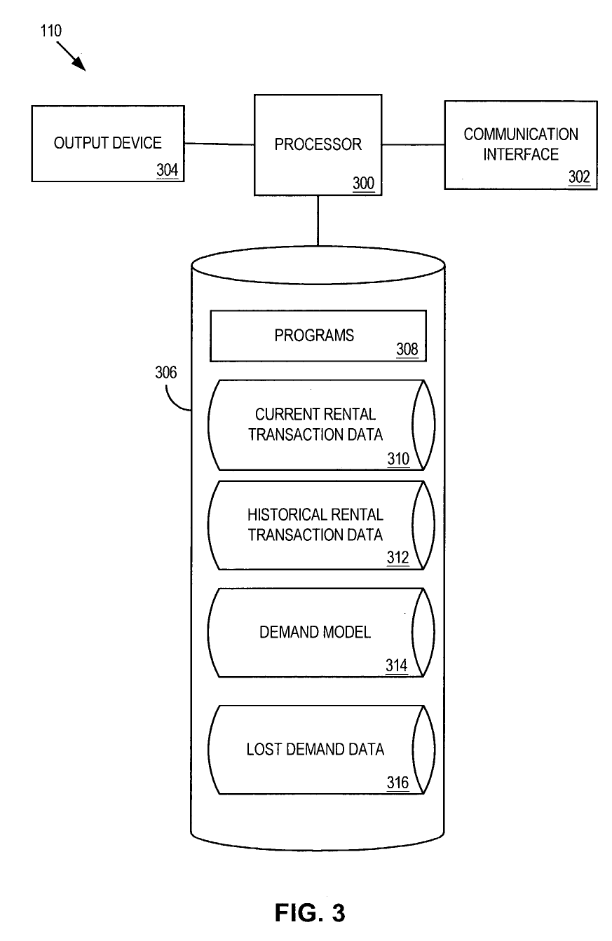

FIG. 3 is a block diagram which shows some details of the central data processing system 110. The central data processing system 110 includes a processor 300, which may be a conventional microprocessor, or a number of processors operating in parallel. The processor 300 is in data communication with a communication interface 302, through which the central data processing system 110 communicates with other components of the information management system 100, including the facility computers 104. The processor 300 is also in data communication with one or more output device(s) 304, which may include one or more displays and/or printers. (Although not shown in the drawing, the central data processing system 110 may also include one or more input devices, such as keyboards and mice, in data communication with the processor 300.)

Also included in the central data processing system 110 is a storage device 306, such as a conventional hard disk drive or group of hard drives, in data communication with the processor 300. The storage device 306 stores a number of programs 308 which are provided in accordance with the invention to control the processor 300 so that the central data processing system 110 operates in accordance with one or more aspects of the present invention. Also stored in the storage device 306 are one or more databases and/or data structures, including a current rental transaction database 310, a historical rental transaction database 312, a demand model 314, and a lost demand database 316.

The current rental transaction database 310 may store rental transaction data that has been recently uploaded to the central data processing system 110 from the facility computers 104. The rental transaction data stored in the current rental transaction database 310 may be such as to provide a complete picture of the status (e.g., rented, not rented, reserved for rental in the future) of all storage units 108 of all of the rental facilities 102. For storage units that are rented, the rental transaction data stored in the current rental transaction database 310 may indicate, for example, the applicable rates as well as dates on which currently effective rental agreements are due to terminate. The current rental transaction database 310, or a related database which is not separately shown in the drawing, may include one or more summaries of the rental transaction data uploaded from the facility computers 104 to the central data processing system 110. The current rental transaction database may also store demographic information related to customers who rented storage units and/or customers' reasons for renting the storage units. This information may have been uploaded from the facility computers 104 to the central data processing system 110. This data may be useful in terms of decision support and/or long-term management of the rental facilities 102 or in determining whether to build or acquire additional rental facilities.

The historical rental transaction database 312 may store data that indicates status of all storage units during past periods of time, including, for example, one, two, three or more past years. The data stored in the historical rental transaction database 312 may be raw data that has been uploaded from the facility computers 104 to the central data processing system 110 in regard to the past periods of time. Alternatively, or in addition, the historical rental transaction database 312 may include summary data derived from the data that has been uploaded from the facility computers 104 to the central data processing system 110. The summary data may, for example, indicate what percentages of storage units, by type, were rented at each of the rental facilities 102 at particular times in the past, and at what rental rates or base rental rates. Statistical data relating to past periods, including past customer demographics and/or motivations of past customers may also be included in the historical rental transaction database 312.

The demand model 314 may provide a mathematical model of the demand for storage units as a function of season, for example. The demand model 314 may be generated on the basis of data stored in the historical rental transaction database 312. The demand model 314 may reflect other factors, in addition to or in place of season. Such other factors may include, for example, national or regional economic conditions.

The lost demand database 316 may store data that has been uploaded from the facility computers 104 to the central data processing system 110 in regard to rental transactions that could not be completed for various reasons. For example, the lost demand database 316 may store data that is indicative of rental transactions that could not be completed due to a lack of available storage units of a particular type. The lost demand database may also store data indicative of inquiries to rent storage units in rental facilities which are completely occupied.

Some or all of the current rental transaction database 310, the historical rental transaction database 312, the demand model 314 and the lost demand database 316 may be employed for purposes of revenue management analysis, as will be described below.

Software Functions

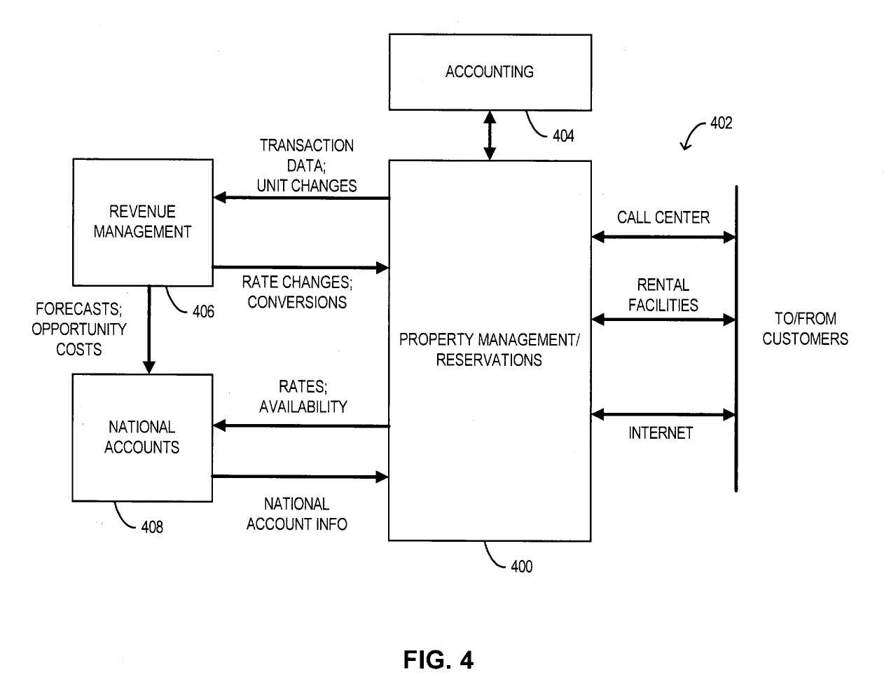

FIG. 4 illustrates in the form of a block diagram various functions that may be performed by the programs 308 referred to in connection with FIG. 3. Continuing to refer to FIG. 4, block 400 indicates generally a property management and storage unit reservations function. Some details of this functional block will be discussed below. As indicated at 402, customer input, including requests for reservations, may be received by the property management and storage unit reservations function 400 via (a) a call center (not shown) which may be maintained by the owner of the rental facilities to receive storage unit reservation bookings from customers via telephone; (b) communications from facility computers 104 regarding rental transactions, including reservations, made by customers who are present at the rental facilities 102; and (c) direct customer contact via the Internet. To allow for direct customer contact for reservations via the Internet, the central data processing system 110 may be arranged to function as a web server and may be connected to the Internet.

Block 404 in FIG. 4 represents an accounting function. The accounting function 404 may handle receipt and recording of deposits and rental payments and may also deal with billing, credit card payment validations and collections, expenses of the various rental facilities and accounts payable. Data is exchanged between the accounting function 404 and the property management and storage unit reservations function 400. For example, the accounting function 404 may receive from the property management and storage unit reservations function 400 data indicative of deposits and initial rental payments received, or data required for credit card transactions. The accounting function 404 may provide to the property management and storage unit reservations function 400 data indicative of storage units for which payments are in good standing and storage units for which payments are late, thus enabling the property management and storage unit reservations function 400 to take appropriate steps such as generating letters to customers to request payment and/or terminating storage unit rental agreements.

The accounting function 404 may also generate periodic (e.g., daily, weekly, monthly, annual) reports relating to revenues, expenses and/or profits on a facility-by-facility and/or system-wide basis.

Block 406 in FIG. 4 represents a revenue management function. Additional details of this function will be provided below. In general, the revenue management function 406 operates to generate recommendations relating to price changes for the purpose of maximizing the revenue received for the rental of storage units in the rental facilities. The revenue management function 406 may take into account current occupancy rates for the storage units and historical experiences relating to occupancy rates. The revenue management function 406 also may provide recommendations to convert storage units from one type to another. Such recommendations may relate to changing the sizes of storage units (i.e., combining small storage units to form larger storage units and/or dividing large storage units to form smaller storage units) and or changing climate control characteristics of storage units (e.g., converting storage units that are not climate controlled into storage units that are heated and/or air conditioned). The recommendations regarding storage unit conversions may be based on current occupancy rates for various types of storage units as well as historical experiences relating to occupancy rates.

The revenue management function 406 receives from the property management and storage unit reservation function 400 information in regard to (a) rental transactions (including rentals and reservations of storage units); and (b) operations that have been performed to convert units from one type to another. The revenue management function 406 provides to the property management and storage unit reservation function 400 recommendations regarding (a) changes in rental rates for the storage units in the rental facilities; and (b) conversion of storage units from one type to another.

Block 408 in FIG. 4 represents a national account management function. A national account may be a single customer (e.g., a large corporation) that wishes to rent numerous storage units across a considerable number of rental facilities. The national account management function 408 may be concerned with establishing and managing dealings with national account customers. The national account management function 408 may handle information relating to centralized billing and rental booking arrangements as well as blanket or specific discounts or other pricing benefits provided to national account customers.

The national account management function 408 receives from the property management and storage unit reservations function 400 information relating to (a) applicable rates for storage units in the various rental facilities; and (b) availability of storage units. The rates conveyed to the national account management function 408 from the property management and storage unit reservations function 400 may be subjected by the national account management function to a standard discount or other modifications for the benefit of national account customers. The national account management function 408 may operate such that generally applicable price increases are not applied to storage units that are rented through a national account. The national account management function 408 may process the availability information to generate a list of storage units/rental locations that meets needs of a national account customer that have been inputted into the national account management function 408.

The national account management function 408 may also receive occupancy forecast and estimated opportunity cost information from the revenue management function 406. As will be seen, the occupancy forecast and opportunity cost information may be generated by the revenue management function 406 to aid in guiding pricing strategies both for national account pricing and for generally applicable pricing decisions.

The national account management function 408 provides to the property management and storage unit reservations function 400 information relating to transactions such as storage unit rentals and reservations for national account customers.

Property Management and Reservations

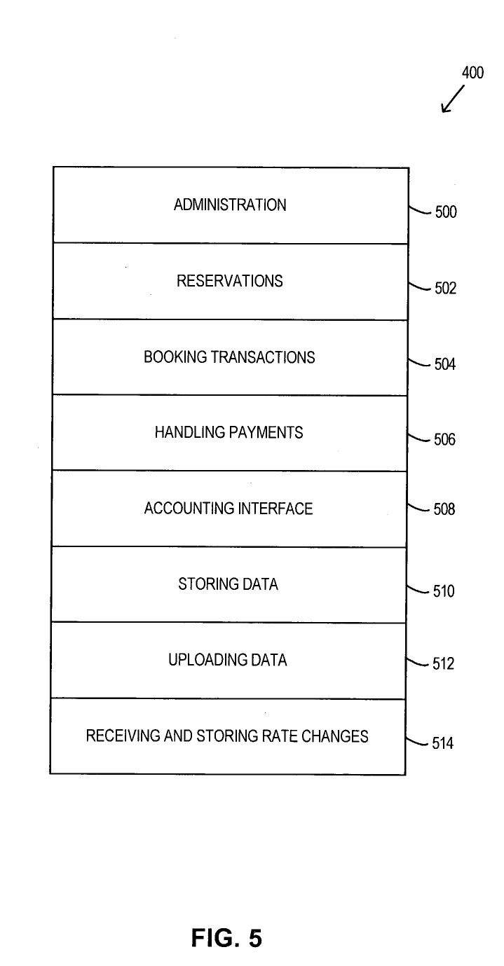

FIG. 5 schematically illustrates functional blocks that are part of the property management and storage unit reservations function 400 of FIG. 4.

The property management and storage unit reservations function 400 includes an administration block 500 that handles various administrative functions relating to the rental facilities. These functions may include: (a) managing access of rental facility employees to the facility computers 104; (b) indicating the status (e.g.: rented, reserved, vacant (available), converted, in use by rental facility) and characteristics (described below) of each storage unit; (c) revising data records to reflect addition or removal of storage units due to conversion; (d) revising data records to reflect changes in climate control characteristics of storage units due to conversion; (e) storing site-specific data regarding the rental facilities (e.g., address, phone number, number of storage units, number of floors, etc.); (f) generating letters reminding customers that payments are in arrears; (g) generating sales support scripts; (h) generating reports; and (i) storing information relating to suppliers.

The property management and storage unit reservations function 400 also includes a reservations block 502 that handles reservations of storage units for rental in the future. Among the functions that may be performed by this block are: (a) receiving requests for reservations, including customer name and contact information, characteristics of the type of storage unit that the customer wishes to reserve, and dates of commencement and termination for proposed rental term; (b) determining whether a storage unit is available that matches a request for a reservation; (c) changing the status of a storage unit from available to reserved and assigning the storage unit to the reservation in question; (d) suggesting alternative storage units if no available storage unit exactly matches a reservation request; (e) retrieving pricing information for the storage unit; (f) indicating what amount of deposit, if any, is required; (g) tracking payment and retention of deposit pending the customer's moving in to the storage unit; (h) storing lost demand information (i.e., information which indicates that a proposed reservation could not be provided, or a proposed rental transaction could not take place, for lack of an available storage unit); (i) storing information about prospective customers who do not elect to make a reservation; and (j) placing prospective customers on a waiting list when no suitable storage unit is available for reservation.

The property management and storage unit reservations function 400 further includes a booking transaction block 504 that handles rental transactions. The following may be among the functions performed by this block: (a) generating rental agreements; (b) storing terms of rental agreements (e.g., start date, end date, applicable rental rate; (c) changing a storage unit's status from vacant or reserved to occupied, or from occupied to vacant; (d) retrieving pricing information for the storage unit; (e) calculating an amount of rental payment that is due at the start of the rental term; (f) applying a deposit, if any, to an amount due; (g) receiving customer name and contact information; (h) receiving demographic information (e.g., age, gender, marital status, home ownership, business type, business size) about a customer; (i) receiving information regarding a customer's reason for renting a storage unit; (j) booking insurance (if desired by the customer) for contents of the storage unit; and (k) calculating refund (if due) upon a customer moving out of a storage unit.

The property management and storage unit reservations function 400 also includes a handling payments block 506 that handles payments received from customers. For example, this block may receive data needed to perform a credit card transaction authorization and subsequent redemption. This block may also operate to receive data indicative of receipt of payment by cash or check. This block may also tie the payment received to a particular rental transaction or reservation.

Also included in the property management and storage unit reservations function 400 is an accounting interface block 508. This block may handle exchange of data between the property management and storage unit reservations function 400 and the accounting function 404 (FIG. 4).

The property management and storage unit reservations function 400 further includes a storing data block 510. This block receives rental transaction data, lost demand data, and possibly other data, uploaded from the facility computers 104 and handles storage of that data in one or more of the current rental transaction database 310 (FIG. 3), the historical rental transaction data 312, the lost demand database 316 and/or other databases (not shown). This block may also reformat, summarize or manipulate the data uploaded from the facility computers 104 or stored in the storage device 306 (FIG. 3) to provide processed information that may be stored in one of the above-mentioned databases.

The property management and storage unit reservations function 400 also includes an uploading data block 512. This block provides the functionality for the facility computers 104 to upload rental transaction data, lost demand data and possibly other data to the central data storage system 110.

Also included in the property management and storage unit reservations function 400 is a receiving and storing rate changes block 514. This block may receive rate changes and/or recommended rate changes from user input and/or from the revenue management function 406 (FIG. 4) and may store rate changes that are applicable to some or all of the storage units. This block may also receive and store information related to marketing promotions (e.g., special and/or limited time price discounts).

It should be understood that many of the functions described in connection with FIG. 5 may be shared between the central data processing system 110 and the facility computers 104. In some embodiments, there may be a client/server relationship between the facility computers 104 and the central data processing system 110 so that the central data processing system 110 performs most of the functions described in connection with FIG. 5 based on input from the facility computers 104. In other embodiments, a large part of those functions may be performed by each facility computer 104 for its respective rental facility 102, based in some cases on data downloaded periodically or on demand from the central data processing system 110.

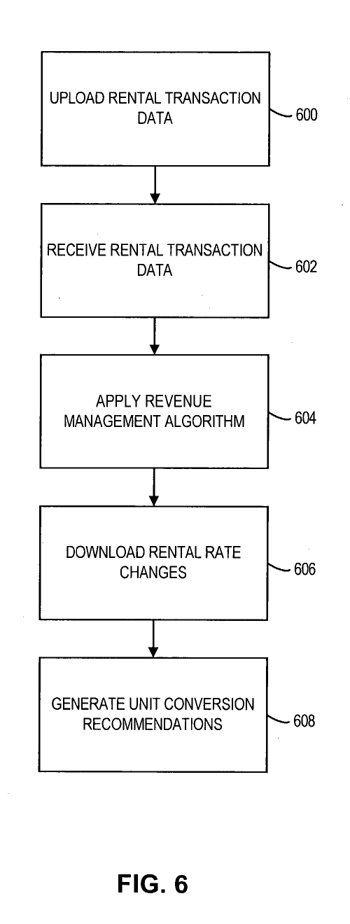

FIG. 6 is a flowchart that illustrates a process performed in accordance with some aspects of the invention. At 600, rental transaction data is uploaded from the facility computers 104 to the central data processing system 110. The uploading of the rental transaction data may occur on a regular basis, such as daily. That is, for example, the rental transaction data for each rental facility 102 may be uploaded by the respective facility computer 104 for the facility at the end of each business day for the facility. As alternatives, the rental transaction data may be uploaded at other regular time intervals, such as weekly or monthly, or may be uploaded on demand from the central data processing system 110. The rental transaction data may be uploaded more frequently than once a day. E.g., the rental transaction data may be uploaded substantially in real time as each transaction occurs. The uploading of the rental transaction data may be initiated by the facility computers 104 or in response to polling messages from the central data processing system 110.

The rental transaction data may be uploaded in a number of different formats. For example, data which represents each individual storage unit rental transaction may be uploaded to the central data processing system 110. Alternatively, summaries of groups of rental transactions may be uploaded, including a total number of new rentals by category of storage unit rented. It may be the case that the central data processing system 110 already stores the applicable rental rates for all of the storage units, in which case data regarding the rates at which the rentals were made need not be uploaded to the central data processing system 110. As still another alternative, the data uploaded may be an updated status report regarding the storage units of the rental facility. Such data is also to be considered “rental transaction data”, since rental transaction activity can be inferred from the updated status data by comparison with a previous status report.

The rental transaction data uploaded from the facility computers 104 to the central data processing system 110 may also include demographic information related to customers who rented the storage units. This information may include, for example, one or more of the age, gender, marital status, household income, home ownership, and so forth, of the customers. The rental transaction data uploaded from the facility computers 104 to the central data processing system 110 may also include data that indicates customers' reasons for renting the storage units. Such reasons may include, for example, that the customer was moving, or needed additional space, or (in the case of a business) was storing excess inventory or supplies, etc.

In addition to or instead of rental transaction data, the facility computers 104 may also upload to the central data processing system 110 so-called “lost demand” data. Lost demand data refers to information that indicates that a rental transaction could not be made with a prospective customer and may include a reason why the transaction could not be made. For example, lost demand data may indicate that a rental transaction could not be completed due to a lack of available storage units of a type requested by a prospective customer, or because the entire rental facility is completely occupied.

At 602, the central data processing system 110 receives the rental transaction data (and possibly also lost demand data) uploaded from the facility computers 104. The central data processing system 110 may parse, analyze or edit the uploaded rental transaction data prior to, as a part of, or subsequently to storing the rental transaction data in one or more databases such as the current rental transaction database 310 (FIG. 3) and the historical rental transaction database 312. Lost demand data, if uploaded, may also be parsed, analyzed or edited by the central data processing system 110 prior to, as a part of, or subsequently to storing the lost demand data in the lost demand database 316.

Revenue Management

Continuing to refer to FIG. 6, at 604 the central data processing system 110 applies a revenue management algorithm utilizing one or more of data stored in the current rental transaction database 310, the historical rental transaction database 312, the demand model 314 and the lost demand database 316.

Revenue management techniques and principles that are generally known may be applied to the goal of maximizing rental revenue from the storage units 108 of the rental facilities 102. In some embodiments, conventional revenue management analysis may be modified or supplemented in certain ways to reflect unique characteristics of the market for storage units.

A wide variety of different types of storage units may be present in a rental facility or network of rental facilities. For example, storage units may be classified by size (typical sizes are: 5×5, 5×10, 5×15, 10×10, 10×15, 10×20, 10×25, 10×30, 10×40; all dimensions in feet); by climate control characteristic (i.e., whether and to what extent the storage unit is heated, cooled, air-conditioned and/or dehumidified; typical climate control categories are: non-climate controlled; dehumidified; heated; air cooled; and “climate controlled” (which means both heated and air conditioned)); by location/access (typical categories are: ground floor; upstairs—stair access only; upstairs—lift access; upstairs—elevator access; basement; outside access) and by general desirability (typical categories are: normal, premium, ultra-premium, economy, super-economy).

In some embodiments, a pricing scheme for all the different kinds of storage units may involve a base price for one type of storage unit, with prices for all the other types of storage units being derived from the base price by use of scaling factors. For example, a base price may be provided for a 100 square foot storage unit that is non-climate controlled, located on the ground floor of the rental facility and of normal desirability. One or more scaling factors may then be applied to the base price to produce a price for a storage unit of a type that differs in one or more ways for the base-price type of storage unit. For example, pricing may be scaled according to size of the storage unit, with an additional scaling factor representing a volume discount or premium. To give a concrete example, the price for a 250 square foot storage unit (which otherwise has the same characteristics as the base-price type of storage unit) may be 2.5 times f_{size} times the base price, where f_{size} is less than one (e.g., 0.9). It will be understood that f_{size} may vary with the size of the storage unit so as to be smaller for larger storage units and larger for smaller storage units, and possibly greater than one for storage units that are smaller than the base-price storage unit.

To give another example, the price for a 100 square foot storage unit that differs from the base-price type of storage unit only in terms of its climate control characteristic may be obtained by multiplying the base price by a scaling factor f_{climate} that may be greater than one for all the climate controlled characteristics other than non-climate controlled. E.g., f_{climate} may be 1.15 for storage units that are dehumidified or heated or air cooled and may be 1.20 for storage units that are climate controlled (i.e., heated and air conditioned).

For still another example, the price for a 100 square foot storage unit that differs from the base-price type of storage unit only in terms of its location/access characteristic may be obtained by multiplying the base price by a scaling factor f_{location} that may be less than one for all characteristics except outside access. For example, f_{location} may be 0.9 for basement or elevator access storage units, 0.8 for lift access storage units, 0.6 for stairs access storage units and 1.15 for outside access storage units.

To provide still another example, the price for a 100 square foot storage unit that differs from the base-price type of storage unit only in terms of its desirability characteristic may be obtained by multiplying the base price by a scaling factor f_{desirability} that may be less than one for economy storage units and greater than one for premium storage units.

In general, the price for any storage unit may be calculated according to the following formula:

Base price×(size(in square feet)/100)×f_{size}×f_{climate}×f_{location}×f_{desirability},

where:

f_{size}=1 for 100 square foot storage units;

f_{climate}=1 for non-climate controlled storage units;

f_{location}=1 for ground floor (inside access) storage units; and

f_{desirability}=1 for normal desirability storage units.

For other types of storage units, the scaling factors f_{size}, f_{climate}, f_{location}, and f_{desirability} may vary as indicated above.

With this scheme it will be recognized that pricing for all different types of storage unit may be defined in terms of a base price and various scaling factors. Other or additional scaling factors may also be employed. For example, if a storage unit has a special feature such as a particularly convenient type of door, an additional scaling factor may be applicable. Revenue management analysis may be performed to recommend changes in the base price and/or one or more of the scaling factors. Revenue management analysis may also be performed to recommend converting storage units from one type to another.

In some embodiments, revenue management analysis may be performed according to the following cycle: On the evening of day 1 rental transaction data is uploaded to the central data processing system 110; during day 2 revenue management analysis is performed based on the uploaded rental transaction data to generate recommended or proposed price changes, including changes in base price and/or scaling factors for one or more rental facilities; price changes based on the revenue management analysis then are downloaded to the respective facility computers 104 on the evening of day 2 (606 in FIG. 6) for application to transactions on day 3 and beyond. This cycle may be varied in a number of ways. For example, revenue management analysis and/or application of price changes may be deferred or may be performed on a weekly or monthly basis. Also, for revenue management analysis that results in recommendations to convert storage units from one type to another (608 in FIG. 6), the implementation of the recommendations may require weeks or months, and may not begin to be implemented for a considerable period of time.

Recommended price changes and/or storage unit conversions may be based on opportunity costs for the various types of storage units. “Opportunity cost” refers to an estimated amount of revenue foregone by renting a particular storage unit rather than having it available for rental at current rates. Opportunity costs may be estimated on the basis of actual and/or forecasted occupancy rates. Occupancy forecasts may be based on current and historical occupancy rates, which may be derived from current and historical rental transaction data. In some embodiments, occupancy forecasts are based on prior year occupancy as modified in light of current occupancy conditions. For example, in some embodiments, if the current month's occupancy rate differs from the prior year occupancy for the corresponding month by a given percentage, the forecast for the next month's occupancy may be obtained by applying the same percentage difference to the occupancy rate for the prior year month corresponding to the next month. In some embodiments, forecasts are based on “smoothed” occupancy rates. For example, a seven day moving average may be employed for both historical and current occupancy rates.

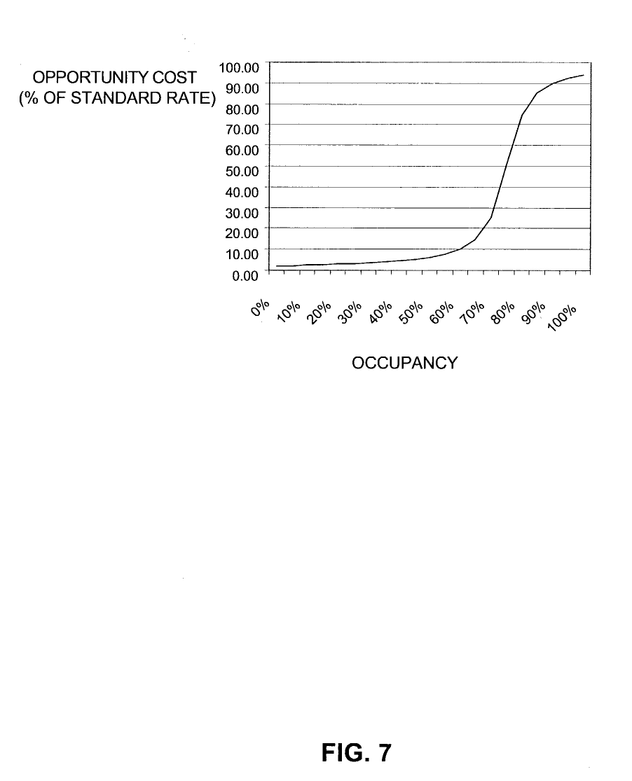

FIG. 7 is a graph that illustrates an example of a function that may be employed to estimate opportunity cost based on a level of occupancy or forecasted occupancy. The figures on the vertical axis in FIG. 7 represent percentages of a “street rate” which is the standard rental rate charged for short term rentals to new customers. The function illustrated in FIG. 7 can be approximated by an ArcTan function, specifically:

(R/2)+(R/π)*ArcTan(A*O−B),

where R is the street rate;

O is the actual or forecasted occupancy;

and B and A are parameters that respectively determine where along the horizontal axis the transition in the function curve will occur and how steep the transition will be.

It will be observed that the opportunity cost function of FIG. 7 is such that the opportunity cost is low when occupancy is low, and is close to the street rate when occupancy is high. In some embodiments, A and B may be selected such that the estimated opportunity cost is low (e.g., 15% or less of the street rate) for three or four months of the year and such that the estimated opportunity cost is high (e.g., greater than 80% of the street rate) when occupancy exceeds 90%.

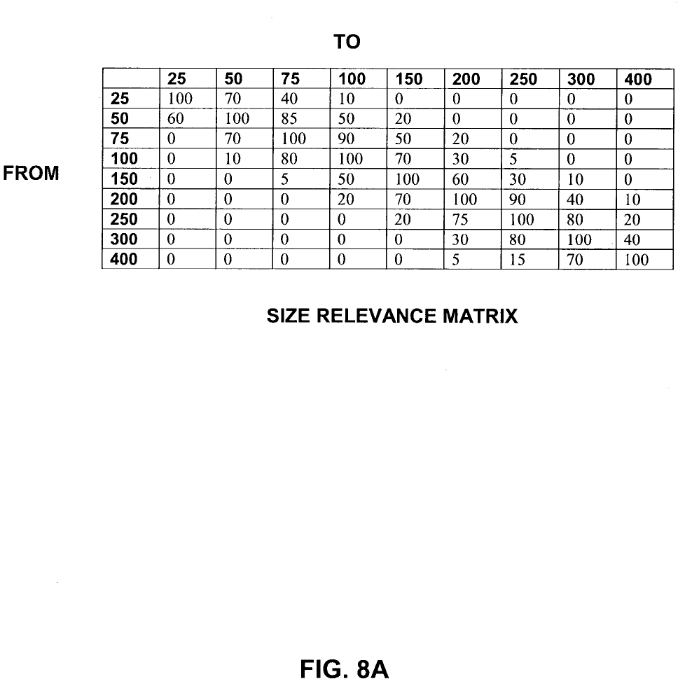

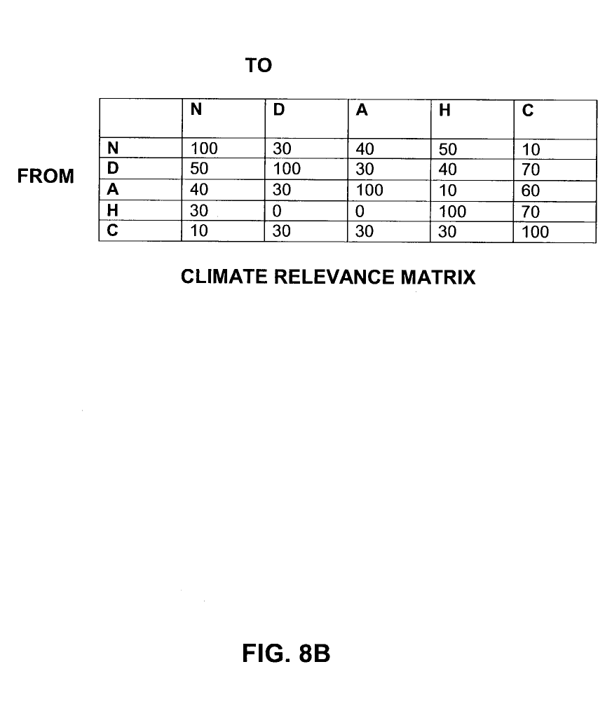

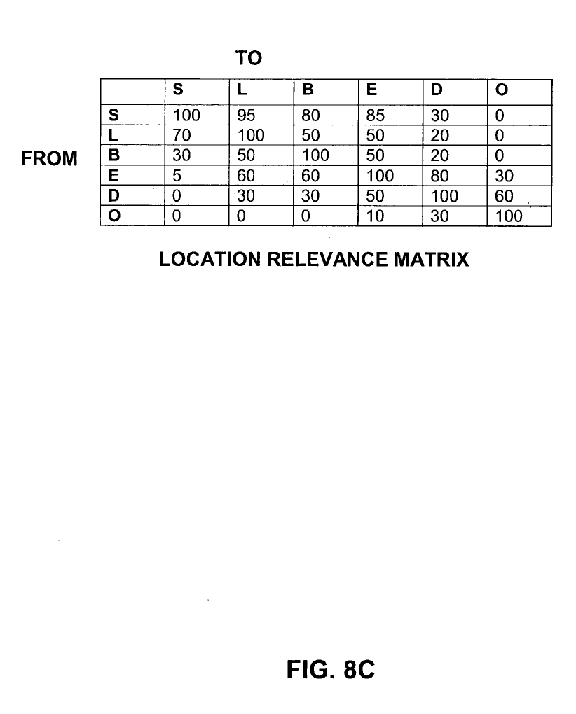

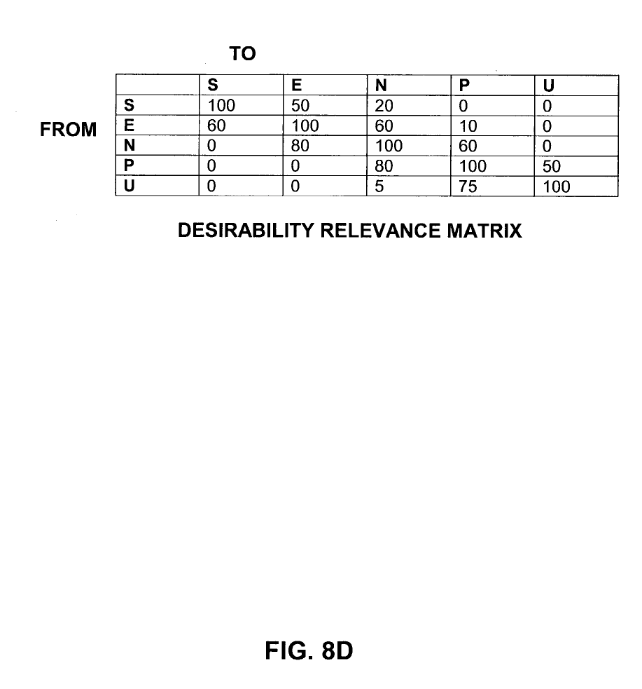

In some embodiments, occupancy forecasts and/or other aspects of revenue management analysis may take into account that different classes of storage units may be somewhat interchangeable from the customers' point of view. That is, for each two classes of storage units there is a certain likelihood (approximately zero in some cases) that a customer will accept a storage unit of one class as a substitute for a storage unit of the other class if no storage unit of the other class is available. Reflecting the potential interchangeability between some classes of storage units, relevance matrices may be formed, as illustrated in FIGS. 8A-8D.

FIG. 8A presents an example size relevance matrix which indicates size relevance factors applicable to pairs of storage unit size classes (indicated in square feet). Each size relevance factor indicates a degree of interchangeability (in percent) between the two different sizes of storage unit making up the corresponding pair of size classes. It will be observed that the pairs of size classes may be ordered in the sense that the substitutability of a first size of storage unit for a second size of storage unit may differ from the substitutability of the second size of storage unit for the first size of storage unit.

FIG. 8B presents an example climate relevance matrix which indicates climate relevance factors applicable to pairs of storage unit classes having different types of climate control characteristics. In FIG. 8B:

N means non-climate controlled;

D means dehumidified;

A means air cooled;

H means heated; and

C means climate controlled (i.e., both heated and air conditioned).

Again in the case of the climate relevance matrix it will be observed that the pairs of climate control characteristic classes may be ordered pairs.

FIG. 8C presents an example location relevance matrix which indicates location relevance factors applicable to pairs of storage unit classes having different types of location/access characteristics. In FIG. 8C:

S means accessed by stairs only;

L means accessed by lift;

B means basement location;

E means accessed by elevator;

D means ground floor location; and

O means outside access.

Once more in the location relevance matrix it will be observed that the pairs of location/access characteristic classes may be ordered pairs.

FIG. 8D presents an example desirability relevance matrix which indicates desirability relevance factors applicable to pairs of storage unit classes having different types of desirability characteristics. In FIG. 8D:

S means super economy;

E means economy;

N means normal desirability;

P means premium; and

U means ultra-premium.

In the case of the desirability relevance matrix as well, the pairs of desirability characteristic classes may be ordered pairs.

The particular relevance factor values shown in the four relevance matrices of FIGS. 8A-D are only examples of factor values that may be estimated and/or determined based on surveys and/or empirical studies of customer preference or behavior. The degree of interchangeability reflected by the relevance factors may at least partially reflect price differences between the different classes of storage units. The relevance matrices may vary from rental facility to rental facility and may be stored as part of the demand model 314 stored in the storage device 306 of the central data processing system 110.

When two storage units differ from each other in terms of two or more characteristics, the aggregate relevance factor for the two storage units may be obtained as the product of the individual characteristic relevance factors.

Current, historical and forecasted occupancy rates for any particular class of storage unit may be calculated using actual occupancy of that class of storage unit and actual occupancy rates of other classes weighted by applicable relevance factors.

In addition to taking into account current, historical and/or forecasted occupancy and/or relevance factors, revenue management analysis in some embodiments and the resulting rental rate change recommendations and/or storage unit conversion recommendations may also take into account demand functions for storage units or classes of storage units. A demand function is a relation between the quantity of a product demanded and its determinants. In the case of storage units the determinants may include price and time of year. The demand functions may be estimated and/or based on empirical data.

Rental rate change recommendations and/or storage unit conversion recommendations may also be based wholly or in part on lost demand data.

The information management system described herein is advantageous in that the system may enable an operator of a chain of storage unit rental facilities to gather, store, manage and analyze key information relating to operation of the rental facility chain in a timely manner. Management and profitability of the rental facility chain may thereby be improved. The information may be utilized for revenue management analysis, so that the occupancy rates for the rental facilities may be maximized at optimal rental rates. In this way, revenue for the rental facility may be maximized to produce higher profits.

The present invention has the technical effect of providing data to a central location more rapidly than prior systems.

The central data processing system described herein may be constituted by one computer or by two or more computers that are linked together. Moreover, although only one facility computer 104 is shown as being present at each rental facility 102, there may be two or more facility computers at at least some of the rental facilities.

As used herein and in the appended claims, “database” may refer to one or more related or unrelated databases. Data may be “stored” in raw, excerpted, summarized and/or analyzed form.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A system comprising:
a central data processing system in which a database is maintained; and
a plurality of facility computers each located at a respective rental facility and configured to engage in data communication with the central data processing system, the rental facilities each including a plurality of storage units that are rented or available for rental to customers;
the facility computers being programmed to upload rental transaction data to the central data processing system on a daily basis, the rental transaction data being related to rentals of the storage units, the rental transaction data being stored in the database.

2. The system of claim 1, wherein the facility computers are programmed to upload the rental transaction data to the central data processing system on a real-time basis.

3. The system of claim 1, wherein rental transaction data stored in the database corresponds to a period of at least one year prior to a current time.

4. The system of claim 3, wherein rental transaction data stored in the database corresponds to a period of at least two years prior to a current time.

5. The system of claim 1, wherein rental transaction data stored in the database corresponds to a period of at least three years prior to a current time.

6. The system of claim 1, wherein the rental transaction data includes demographic information related to customers who rented the storage units.

7. The system of claim 6, wherein the rental transaction data includes data indicative of the customers' reasons for renting the storage units.

8. The system of claim 1, wherein the rental transaction data includes data indicative of customers' reasons for renting the storage units

9. The system of claim 1, wherein the central data processing system stores data indicative of rental transactions that could not be completed due to a lack of available storage units of a particular type.

10. The system of claim 1, wherein the plurality of facility computers includes at least 100 facility computers.

11. The system of claim 1, wherein the central data processing system is located remotely from the rental facilities.

12. The system of claim 1, further comprising:
a data network interconnecting the central data processing system and the facility computers, the network including at least one of digital subscriber lines and Frame Relay network connections.

13. The system of claim 1, wherein the database stores information indicative of characteristics of each storage unit of each of the rental facilities.

14. The system of claim 13, wherein the database stores information indicative of a size, a location and a climate control characteristic of each storage unit of each of the rental facilities.

15. A method comprising:
collecting rental transaction data at each of a plurality of rental facilities, the rental facilities each including a plurality of storage units that are rented or available for rental to customers, the rental transaction data related to rentals of the storage units; and
uploading the collected rental transaction data to a central data processing system on a daily basis.

16. The method of claim 15, wherein the uploading includes uploading the collected rental transaction data to the central data processing system on a real-time basis.

17. The method of claim 15, further comprising:
storing the uploaded rental transaction data for a period of at least one year prior to a current time.

18. The method of claim 17, further comprising:
storing the uploaded rental transaction data for a period of at least two years prior to a current time.

19. The method of claim 18, further comprising:
storing the uploaded rental transaction data for a period of at least three years prior to a current time.

20. The method of claim 15, wherein the rental transaction data includes demographic information related to customers who rented the storage units.

21. The method of claim 20, wherein the rental transaction data includes data indicative of the customers' reasons for renting the storage units.

22. The method of claim 15, wherein the rental transaction data includes data indicative of customers' reasons for renting the storage units.

23. The method of claim 15, further comprising:
storing data indicative of rental transactions that could not be completed due to a lack of available storage units of a particular type.

24. The method of claim 23, wherein the data indicative of transactions that could not be completed is stored in the central data processing system.

25. The method of claim 15, wherein the plurality of rental facilities includes at least 100 rental facilities.

26. The method of claim 15, wherein the uploading includes transmitting the collected rental transaction data via satellite up-links.
